(19) United States
(12) Patent Application Publication
(10) Pub. No.: US 2007/0025507 A1
(43) Pub. Date: Feb. 1, 2007

(54) Imaging process and device

(75) Inventors: Michael Grass, Buchholz in der Nordheide (DE); Volker Rasche, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/571,821

(22) PCT Filed: Sep. 16, 2004
(86) PCT No.: PCT/IB04/51782

§ 371 Date: Mar. 15, 2006

(30) Foreign Application Priority Data
Sep. 18, 2003 (EP) 03103448.1

(51) Int. Cl. G01N 23/04

(52) U.S. Cl. 378/62

(57) ABSTRACT

The invention relates to an imaging process with a beam source attached at a first end of an holder device, and with a detector unit attached to a second end of the holder device. The holder device is moved so that the beam source is guided about an examination area along a non-circular trajectory, where the beams emitted by the beam source pass through the examination area. The detector unit acquires measurement values which depend on the intensity of the beams on the far side of the examination area. From these measurement values using a filtered back projection an image of the examination area can be reconstructed, where each measurement value is filtered along a filter line which runs parallel to the tangent of the trajectory at the respective position of the beam source.

The invention relates to an imaging process in which an examination area is irradiated by a beam from a beam source moving relative to the examination area, where the beam source is attached at a first end of an holder device and a detector unit is attached at a second end of the holder device. The invention also relates to a device for performance of the process and to a computer program to control the device.

Processes of the type described in the opening paragraph can for example be performed with known radiography systems where the beam source is guided essentially on an orbit about the examination area in which a patient may be present. While the beam source moves, the detector unit acquires measurement values from which using filtered back projection an absorption distribution in the examination area is reconstructed.

The disadvantage with this process is that because of instabilities of the radiography system, in reality the beam source does not move on an ideal orbit but deviates from this. These deviations from the ideal orbit are not taken into account on filtration during the filtered back projection, which leads to artifacts in the reconstructed absorption images.

The object of the present invention is to specify a process, a device and a computer program in which these artifacts are less pronounced. This object is achieved according to the invention by an imaging process with the steps

a) generation of a beam passing through an examination area with a beam source which is arranged at a first end of a holder device,

b) generation of a relative movement between the beam source and the examination area along a non-circular trajectory, which in particular runs over a spherical surface, by movement of the holder device, the beam source passing through different beam source positions,

c) acquisition of measurement values which depend on the intensity in the beam on the far side of the examination area, with a detector unit attached at a second end of the holder device, during the relative movement,

d) reconstruction of an image of the examination area using a filtered back projection of the measurement values, where each measurement value is filtered along a filter line which runs parallel to a tangent of the trajectory at the beam source position concerned.

This process is performed with a non-circular trajectory, which can for example as stated initially be an essentially circular trajectory which because of instabilities of the holder device deviates from an ideal orbit.

From measurements it is known that such deviations are reproducible on repeated passages so that the trajectory actually traveled with its deviations from an ideal orbit is known. The deviations from the ideal orbit are taken into account as the measurement values are filtered along filter lines which run parallel to a tangent of the actually non-circular trajectory at the beam source position concerned. This leads to a reduction in the artifacts mentioned above.

As claimed in claim 2 the tangents are either local or global tangents. The local tangent of a beam source position on the trajectory runs tangential to the trajectory at this beam source position and can be determined with known processes. Thus for example the local tangent for a beam source position can be determined by adapting, with the help of known adaptation algorithms, a straight line at these beam source positions and the two beam source positions adjacent to this. This straight line is the local tangent. The straight line can be adapted so that the sum of the quadratic distances of the straight lines to the beam source positions concerned is minimal.

The global tangent does not run tangential to the trajectory at a particular beam source position, but takes into account several tangents at different adjacent beam source positions. The global tangent is usually a secant and can be determined for a particular number of adjacent beam source positions by adding the tangent vectors of the local tangents concerned. The resulting vector points in the direction of the global tangent. Another possibility of determining a global tangent is to adapt a straight line, as described above for the local tangent, to the adjacent beam source positions for which a global tangent is to be determined. The adapted straight line is the global tangent. The use of local tangents leads to a further reduction in the above-mentioned artifacts while the calculation complexity is reduced by the use of global tangents.

As claimed in claim 3 a preferred embodiment is described which allows the reconstruction of images with excellent quality.

A device to perform the process according to the invention is described in claim 4.

Claim 5 defines a computer program to control a computer tomograph as claimed in claim 4.

The invention will be further described with reference to examples of embodiments shown in the drawings to which, however, the invention is not restricted.

These show:

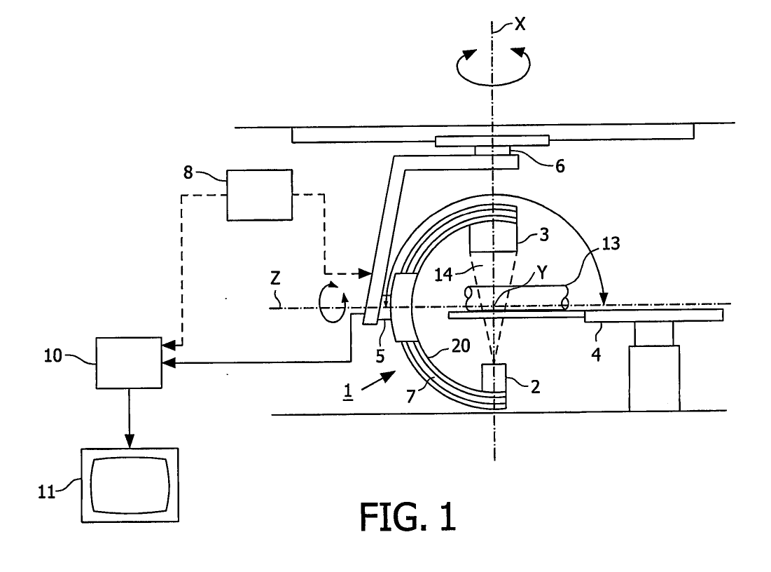

FIG. 1 a C-arm device with which the process according to the invention can be performed;

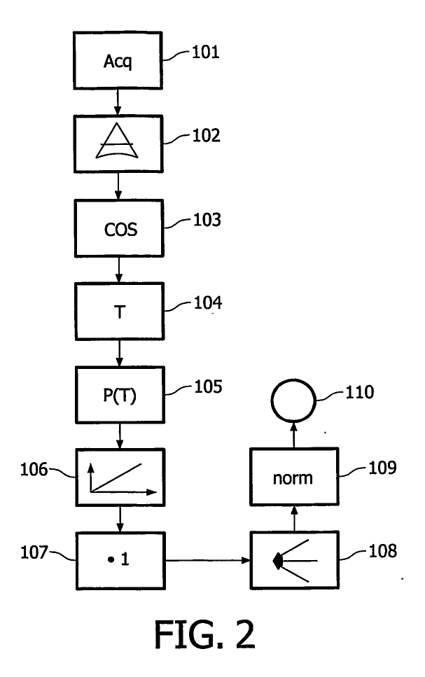

FIG. 2 a flow diagram of the process according to the invention;

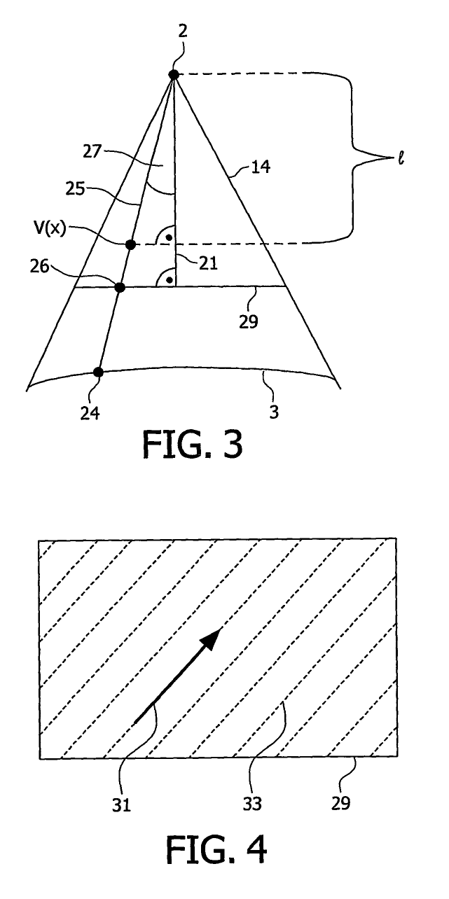

FIG. 3 a diagrammatic view of a radiation source, a real and a virtual detector surface;

FIG. 4 a detector surface with filter lines; and

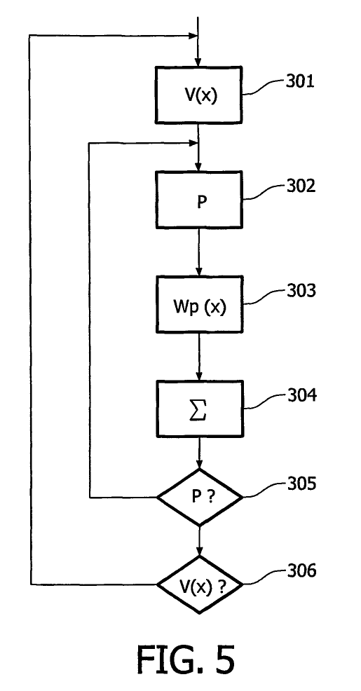

FIG. 5 a flow diagram describing one embodiment of a filtered back projection.

The C-arm device 1 shown in FIG. 1 has a beam source 2 arranged at one end of a holder device 20, in this example C-shaped, and a detector unit 3 arranged at the other end of the holder device 20. The beam source 2 in this embodiment example is an X-ray tube 2 and the detector unit 3 is here an X-ray detector 3. The X-ray tube 2 generates a conical X-ray beam 14 which passes through an examination object, for example a patient, arranged on a patient table 4 in the examination area 13 and then meets the two-dimensional X-ray detector 3. The X-ray tube 2 and X-ray detector 3 can be rotated about a y-axis by means of rails 7 attached to the holder device 20. The y-axis in FIG. 1 is oriented orthogonal to the drawing plane. Because of the suspension by means of several arms and joints 5, 6, the position of the holder device 20 can be modified in various directions for example the holder device 20 can rotate about the x, y or z axis shown in FIG. 1 or also simultaneously about several axes. Also the patient table 4 can be moved in the z-direction. Both the rotation movements of the holder device and the translation movement of the patient table 4 can be performed either manually or by motors not shown in FIG. 1. In this way the beam source 2 can move relative to an examination area 13 on a spherical or cylindrical surface.

The measurement values acquired by the detector unit 3 which in this embodiment example depend on the intensity of the X-radiation, are supplied to a reconstruction computer 10 which from these measurement values reconstructs the absorption distribution in at least one part of the examination area 13. The reconstructed image is shown for example on a monitor 11. The beam source 2, the motors, detector unit 3, holder device 20, reconstruction computer 10 and transfer of the measurement values from this detector unit 3 to the reconstruction computer 10 are controlled by a control computer 8.

FIG. 2 shows the sequence of a measurement and reconstruction process which can be performed with the C-arm device in FIG. 1.

In step 101 the measurement values are acquired. For this first the beam of the beam source is switched on. Then the beam source is moved relative to the examination area so that the beam 14 passes through the examination area 13 from different directions. In this embodiment example the holder device 20 rotates about the z-axis so that the beam source moves on an essentially circular trajectory relative to the examination area. Alternatively the beam source can move along a trajectory which runs in any way on a spherical or cylindrical surface.

In step 102 a virtual detector 29 is defined which in this embodiment example is planar and arranged between the beam source 2 and the detector unit 3 (see FIG. 3). The size of the virtual detector is selected such that all beams of a projection meet this detector. A projection is defined here as the quantity of beams emitted from the same beam source position. The measurement values are projected along the associated beams to the virtual detector surface 29 i.e. along those beams which are emitted by the beam source position concerned and meet the detector surface at the point at which the measurement value is located. The following steps are then performed with these measurement values projected onto the virtual detector surface 29. In other embodiments the virtual detector 29 could co-incide with the real detector 3 so that the following steps are executed on the real detector 3.

If the detector unit 3 has an image amplifier, because of the curved surface of the-image amplifier a pincushion distortion occurs. Furthermore the measurement values can be falsified by the influence of the earth's magnetic field. The measurement values affected by these two influences can be corrected by means of a calibration step so that they are then present in a Cartesian arrangement on a virtual planar detector. This method of calibration is generally known and described for example in E. Koppe, J. Op de Beek and H. Aerts, “3D vessel reconstruction based on rotational angiography”, Computer Assisted Radiology (CAR 95), Berlin, Germany, Springer 1995 (Z1) and R. Koppe, E. Klotz, J. Op de Beek and H. Aerts “Digital stereotaxy/stereotactic procedures with C-arm based rotational angiography”, Computer Assisted Radiology (CAR 98), Amsterdam, The Netherlands, Elsevier Science, 1998 (Z2). They can be performed instead of step 102.

Next in step 103 each measurement value is multiplied with a weighting factor. The weighting factor of a measurement value at point 24 on the detector 3 or at point 26 on the detector surface 29 corresponds to the cosine of the angle 27 between the beam 25 belonging to the measurement value concerned and the normal 21 of the virtual detector 29 running through the beam source 2. This angle is shown in FIG. 3. The fact that the weighting factor corresponds to this cosine means that the weighting factor is essentially equal to the cosine, for example represented by a Taylor development of the cosine. Furthermore the cosine of the angle or the angle itself can have an additive or multiplicative constant. In this embodiment the weighting factor is equal to this cosine.

In the next step 104 the tangents of the trajectory are determined on which the beam source 2 moves relative to the examination area 13. In this embodiment example for each beam source position on the trajectory a local tangent is determined. The local tangent at a beam source position as already described above is calculated using three beam source positions in the known manner using the two adjacent beam source positions on the trajectory. More than the two adjacent beam source positions could be used to calculate the tangent, where this tangents would then be not a local but a global tangent in the context of the invention.

A local tangent to a beam source position can for example be calculated if a straight line at this beam source position and the two adjacent beam source positions is adapted with known adaptation algorithms. The adapted straight line is the local tangent. Correspondingly a global tangent can be determined by adapting a straight line with known adaptation algorithms at more than three adjacent beam source positions. This straight line is then the global tangent of the beam source positions taken into account in the adaptation. If a beam source position lies at an end of the trajectory, a local tangent for this beam source position can be determined by laying a straight line through this beam source position and the adjacent beam source position. The straight line constitutes the local tangent of the trajectory at this beam source position.

As part of the invention, individual discrete beam source positions are discussed although the beam source moves continuously. However measurements are not made continuously but for example 1000 times a second. Although the beam source moves continuously therefore only beam source positions are taken into account at which the beam source was located when measurement values were acquired.

Next in step 105 the tangents are projected onto the detector surface 29 defined in step 102, projection takes place in the normal direction to the detector surface 29. A projection 31 of a tangent at a beam source position on the detector surface 29 is shown as an example in FIG. 4.

If in other embodiments the detector surface 29 defined in step 102 is not flat, then the projection runs along the normal 21 of the virtual detector 29 which runs through the beam source 2.

In step 106 the measurement values weighted in step 103 are subjected to a mono-dimensional filtration in the known manner, for example with a ramp-like transmission factor rising ramp-like with the spatial frequency. For this successive values are taken along filter line 33 which run parallel to projection 31 of the tangent concerned. As the measurement values on the detector surface 29 are not usually arranged parallel to the projection 31 of the tangent concerned, the measurement values must be interpolated so'that they are arranged along the filter lines. Preferably the interpolated measurement values are arranged equidistant on the filter lines. The interpolation is performed so that each measurement value contributes to at least one interpolated measurement value lying on the filter line. The interpolation can be performed with a bilinear interpolation or an interpolation of higher order. Filtration is performed for all projections.

Next in step 107 all weighted and filtered measurement values are multiplied with a further weighting factor. This weighting factor is proportional to the length of the section of the trajectory which can be allocated to the beam source position belonging to the measurement value concerned. In this embodiment example the weighting factor is equal to this length. The length of a section of a trajectory which can be allocated to a beam source position can be determined by adding the distances of a beam source position along the trajectory to the two adjacent beam source positions and divided by two. If a beam source has only one adjacent beam source position —if for example it is arranged at the beginning or end of the trajectory —the length of the corresponding trajectory section can be determined by establishing the distance of the beam source position to the one adjacent beam source-position along the trajectory. In this way for each beam source position a length of a trajectory section can be determined. As a beam source position is allocated to each measurement value, a corresponding length is allocated to each measurement value, with which the measurement value concerned is multiplied.

In step 108 there is a back projection of the measurement values weighted in step 107. A flow diagram for the back projection is shown in FIG. 5.

After an area to be reconstructed (field of view, FOV) has been prespecified, in step 301 a Voxel V(x) is selected within the FOV which is not yet reconstructed.

In the next step 302 a projection is determined which passes through the Voxel V(x) and has not yet contributed to reconstruction of this Voxel V(x).

Next in step 303 all measurement values of this projection are multiplied again with a weighting factor. This weighting factor is proportional to the square of a length 1 of the distance of the Voxel V(x) from the beam source position projected onto the normal 21 of the detector surface 29 which runs through the beam source 2 (see FIG. 3). In this embodiment example this weighting factor is equal to the square of the length 1.

In step 304 the measurement value of the projection, of which the beam passes through the center of the Voxel V(x), is added to the Voxel V(x) or more precisely the Voxel value which is initially equal to 0. If none of the beams of the projection run centrally through this Voxel, a corresponding beam or corresponding measurement value is determined by interpolation of adjacent measurement values.

In step 305 it is checked whether all projections which pass through the Voxel V(x) have been taken into account in reconstruction of this Voxel. If this is the case we proceed with step 306. Otherwise step 302 follows.

In step 306 it is checked whether all Voxels in the FOV have been reconstructed. If this is the case the back projection is ended and we proceed with step 109. Otherwise step 301 follows.

After the weighted and filtered measurement values have been back projected, the reconstructed Voxel is normalized in step 109. This can be achieved for example by each Voxel or its Voxel value being divided by the number of projections which have contributed to the Voxel concerned.

After standardization the absorption in the entire FOV is determined and the imaging process is ended (step 110).

In this embodiment example the beam source 2 moves relative to the examination area 13 on an essentially circular trajectory. As stated initially the beam source however does not run on an ideal orbit but deviates from this orbit. The imaging process according to the invention is not based on this ideal orbit but takes account of the actual non-circular trajectory both in filtration and in back projection. The trajectory here need not be essentially circular as in this embodiment example. Rather the process according to the invention can be performed with any trajectory, even non-planar.

It is known that if a beam source with conical beam moves relative to an examination area along a planar trajectory, the parts of the examination area which do not lie in the trajectory plane cannot be reconstructed with a precise reconstruction process as the acquired data record is not complete. A data record is complete if for each site to be reconstructed in the examination area, each plane containing this site intersects the trajectory at least once, and if this site is passed through by beams emitted from at least one of these intersection points of the plane concerned. Even if an incomplete data set is reconstructed with an approximative reconstruction process, image artifacts occur which are attributable to the incompleteness. The process according to the invention is not restricted to a particular trajectory but can be performed with any non-circular trajectories. Therefore during acquisition the beam source is guided relative to the examination area such that the set of measurement values is complete, which in comparison with processes restricted to essentially planar trajectories leads to reconstructed images of better quality.

In order to obtain the course of the actual trajectory, the C-arm device can be calibrated before the acquisition of measurement values in step 101. With this known calibration a calibration object, in this embodiment example a dodecader with a ball arranged on each corner, is arranged in the examination area. The beam source is now moved along a desired trajectory, whereby projections are acquired from which the balls, in particular their positions, are identified. The balls can be identified for example directly from the projections or using a filtered back projection. The known positions of the balls of the calibration object are compared with the positions determined from the acquired projections, where from this comparison in the known manner the actual trajectory can be concluded. Such a calibration is described amongst others in Z1 and Z2. The course of the actual trajectory can be reproduced during the actual measurement so that for the filtered back projection the trajectory determined by the calibration can be used.

Steps 104 and 105 which describe the determination of the tangents and projections of these tangents onto the detector surface are independent of step 103 in which the measurement value is multiplied with a weighting factor. Therefore steps 104 and 105 can be exchanged with step 103.

### REFERENCE LIST

V(x) point in examination area
1 C-arm device
2 Beam source
3 Detector unit
4 patient table
5, 6 Arms and joints
7 Rails
8 Control computer
10 Reconstruction computer
11 Monitor
13 Examination area
14 Beam
20 Holder device
21 Normal to a detector surface
24 place on the detector unit
25 Beam
26 place on the virtual detector surface
27 Angle between a beam and a detector normal
29 Virtual detector surface
31 Tangent projected on the virtual detector
33 Filter line

1. Imaging process with the steps
a) generation of a beam (14) passing through an examination area (13),
b) generation of a relative movement between the beam source (2) and the examination area (13) along a non-circular trajectory, which in particular runs over a spherical surface, by movement of a holder device (20), the beam source passing through different beam source positions,
c) acquisition of measurement values which depend on the intensity in the beam (14) on the far side of the examination area (13) with a detector unit (3),
d) reconstruction of an image of the examination area (13) using a filtered back projection of the measurement values, where each measurement value is filtered along a filter line which runs parallel to a tangent of the trajectory at the beam source position concerned.

2. Imaging process as claimed in claim 1, characterized in that the tangent concerned is a local or global tangent.

3. Imaging process as claimed in claim 1, characterized in that the reconstruction in step d) has the following steps:
definition of a detector surface (29) and projection of each measurement value along the associated beam onto the detector surface,
multiplication of each measurement value with a weighting factor which corresponds to the cosine of the angle (27) between the normal (21) of the detector surface (29) running through the beam source and the beam (25) belonging to the measurement value concerned, in particular is equal to this cosine,
determination of the respective tangent of the trajectory for each beam source position on the trajectory,
projection of the tangents onto the detector surface (29) in the normal direction of the detector surface (29),
filtration of the measurement values on the detector surface (29) along filter lines which run parallel to the tangents projected onto the detector surface (29), and
back projection of the weighted and filtered measurement values.

4. Device for performance of the process as claimed in claim 1, with
a beam source (2) to generate a beam (14), in particular conical, passing through an examination area (13),
a drive device to generate a relative movement between the beam source (2) and the examination area (13) along a non-circular trajectory which in particular runs over a spherical surface,
a detector unit (3) for acquisition of measurement values which depend on the intensity in the beam (14) on the far side of the examination area (13),
an holder device (20), where at a first end of the holder device (20) the beam source (2) is arranged and at a second end of the holder device (20) the detector unit (3) is arranged,
a reconstruction unit (10) for reconstructing an image of the examination area (13) using a filtered back projection of the measurement values, where each measurement value is filtered along a filter line which runs parallel to a tangent of the trajectory at the beam source position concerned.

5. Device as claimed in claim 4, comprising a control unit (8) to control the beam source (2), the drive device, the detector unit (3), the holder device (20) and the reconstruction unit (10) according to the following steps:
a) generation of a beam (14) passing through an examination area (13) with a beam source (2) which is arranged at a first end of the essentially C-shaped holder device (20),
b) generation of a relative movement between the beam source (2) and the examination area (13) along a non-circular trajectory, which in particular runs over a spherical surface, by movement of the holder device (20), the beam source passing through different beam source positions,
c) acquisition of measurement values, which depend on the intensity in the beam (14) on the far side of the examination area (13), using the detector unit (3) attached at a second end of the holder device (20), during the relative movement,
d) reconstruction of an image of the examination area (13) using a filtered back projection of the measurement values, where each measurement value is filtered along a filter line which runs parallel to a tangent of the trajectory at the beam source position concerned.

6. Computer program for a control unit (8) to control a beam source (2), a drive device, a detector unit (3), a holder device (20) and a reconstruction unit (10) of a C-arm device for performance of the process as claimed in claim 1 with the following procedure:
a) generation of a beam (14) passing through an examination area (13), using the beam source (2) which is arranged at a first end of an essentially C-shaped holder device (20),
b) generation of a relative movement between the beam source (2) and the examination area (13) along a non-circular trajectory, which in particular runs over a spherical surface, by movement of the holder device (20), the beam source passing through different beam source positions,
c) acquisition of measurement values, which depend on the intensity in the beam (14) on the far side of the examination area (13), using the detector unit (3) attached at a second end of the holder device (20), during the relative movement,
d) reconstruction of an image of the examination area (13) using a filtered back projection of the measurement values, where each measurement value is filtered along a filter line which runs parallel to a tangent of the trajectory at the beam source position concerned.
